(19) United States
(12) Patent Application Publication
(10) Pub. No.: US 2019/0156056 A1
(43) Pub. Date: May 23, 2019

(54) SYSTEM AND METHOD FOR CONTROLLING ACCESS TO DATA

(71) Applicant: MyLens Inc, Albuquerque, NM (US)

(72) Inventors: Mark Chavez, Albuquerque, NM (US); Cody Eilar, Albuquerque, NM (US); Nathan Stark, Chagrin Falls, OH (US)

(21) Appl. No.: 16/196,039

(22) Filed: Nov. 20, 2018

Related U.S. Application Data
(60) Provisional application No. 62/589,578, filed on Nov. 22, 2017.

(51) Int. Cl. G06F 21/62; H04L 9/30; G06F 21/60; G06K 7/14; H04L 29/08

(52) U.S. Cl. CPC G06F 21/6245; H04L 9/30; H04L 67/104; G06K 7/1413; G06F 21/602

(57) ABSTRACT

A data access control system is disclosed. The data access control system has a data access control module, comprising computer-executable code stored in non-volatile memory, a processor, a user device, and a peer-to-peer device that stores a user data source. The data access control module, the processor, the user device, and the peer-to-peer device are configured to pair the user device with the peer-to-peer device, use the user device to send an activation command to the peer-to-peer device, store an activation data of the peer-to-peer device on a device ledger, use the user device to send a data command to the peer-to-peer device, and use the peer-to-peer device to send a portion of the user data source to a second device based on the data command. Based on the activation data, the peer-to-peer device rejects commands from all other devices other than the user device.

### CROSS-REFERENCE TO RELATED APPLICATIONS

This application claims the benefit of the following provisional application which is hereby incorporated by reference in its entirety: 62/589,578 filed Nov. 22, 2017, the entire disclosure of which is incorporated herein by reference.

### TECHNICAL FIELD

The present disclosure is directed to an automated system and method for controlling access to data and, more particularly, to an automated system and method for an entity to control access to data associated with that entity.

### BACKGROUND OF THE DISCLOSURE

Internet technology has been developed largely with privacy and security as an afterthought. This is evident in data breaches such as the Equifax data breach, where as many as 143 million user's data was apparently compromised. Additionally, technology companies claim ownership of the data that users post on their sites. This data can then be bought and sold without the originator of the content being notified. The Cambridge Analytica data scandal demonstrated that end-user's data is not kept private and can be shared at the company's desire. This is especially true of social media companies that make most of their profits from their user base by giving away access to those users' data in exchange for use of the “free” service.

Data breaches and profits of this magnitude have been made possible in part because of design decisions around these “web 2.0” systems. These systems are engineered to be centralized. Centralized systems are often relatively easier to design and implement than other systems and also have the added advantage of the owner of those systems being able to control how interactions are performed. Their centralized nature allows for easy access to large amounts of aggregated data of their users, which has proven to benefit business decision-making. This model, albeit proven to be typically profitable, is often not in the best interest of end users.

As a result of this market deficiency, many new technologies are surfacing in an attempt to address some of the issues associated with hub-and-spoke designs. Most of the innovation in this area focuses on how to decentralize popular services and to eliminate the central authority that maintains control. Technologies such as Dat, IPFS (interplanetary file system), blockchain, and others are enabling a new wave of decentralized applications increasingly being used on the internet. These tools were designed for very specific goals. Both Dat and IPFS were primarily designed to facilitate file sharing and version control in a peer-to-peer manner. Dat is geared more toward application development and is protocol agnostic (e.g., it doesn't matter if it is implemented over http, https, WebRTC, or other protocols). IPFS is primarily about redefining HTTP/HTTPS. Blockchain was designed largely as a result of trying to create a decentralized ledger where peers could validate transactions on a network collaboratively so that no single server/entity would have a role of determining the order of transactions. These software technologies are providing the basic building blocks for a new future for the web.

Recently, many companies have turned their attention to solving problems of data exploitation and identity. These companies are approaching this decentralized market from different perspectives. Some companies are focused on data ownership, but are simultaneously attempting to provide operability with other hub-and-spoke systems. These are competing ideas: on one hand the company gives users control of how to share their data, but on the other hand the content is shared freely on networks that own that information.

Other attempts are centered around removing a user's footprint completely from infrastructure owned by other entities. Some companies attempt to move users off the cloud by providing a physical device that provides computational and storage power that would otherwise be leveraging a cloud. Additionally, their scope is focused around storage and computing locally, rather than focusing on data ownership (e.g., they are agnostic when it comes to where the data actually is stored). In this approach, data ownership is not beneficially centered around an individual, and a single individual may not control access to his or her digital information.

Identity is a problem that decentralized approaches face. Many blockchain software packages are designed such that anyone or any robot can add themselves to the ledger. This is not desirable for identity purposes, because identity may be beneficially verified in many situations by some authority such as a government, business, or an institution before an entity may be added. This is what makes a unique identification number, which is publicly knowable, useful. In other words, identity is verified by a trusted authority before a number or other identity indicator may be issued to an individual.

The Estonian model provides a relatively new way for identities, authorization, and authentication to be handled. The first step in the model has a great barrier to entry, for good purpose: a user proves their identity before being granted an entry on a public database. Decentralized applications and companies are struggling with this idea because it introduces a central authority.

At the core of many decentralized companies and technologies is data ownership and control. Some companies are attempting to keep data with an individual and then monetize its sale. These companies store data on a blockchain and then users may sell the data should they choose. Other approaches also provide a single source of data for their users, using a blockchain technology to store the data. These approaches may provide an application in which users input substantially all their data into a location (e.g., on a blockchain) and then give access to other networks as the user choses. Though many of the companies using this type of approach attempt to give data back to users and give users some measure of data control, none of these approaches appear to involve a subscription to data and a right to revoke access. For example, as soon as a user chooses to share his or her personal data with an existing platform that was designed to harvest data, the data will typically be immediately exploited by the company operating the platform. Furthermore, blockchains are typically relatively expensive and wasteful when it comes to computation, so from a technological perspective, blockchain may not be the most effective way to give users substantially full control of their data.

Also, conventional platform-centric models involve local data stores for a plurality of platforms encountered by individuals in the marketplace, which puts individual users in the position of having to proliferate their data. Further, no single source of truth for a given individual's data exists under conventional systems, as such data is scattered across platforms and devices.

Additionally, conventional platforms levy demands on the individual's time and data to function and to be continually updated. These impositions burden the individual and waste the individual user's time. Further, conventional platform-centric models exploit individuals by harvesting their data, often for financial gain by entities operating the platform-centric models.

The exemplary disclosed system and method of the present disclosure is directed to overcoming one or more of the shortcomings set forth above and/or other deficiencies in existing technology.

### SUMMARY OF THE DISCLOSURE

In one exemplary aspect, the present disclosure is directed to a data access control system. The data access control system includes a data access control module, comprising computer-executable code stored in non-volatile memory, a processor, a user device, and a peer-to-peer device that stores a user data source. The data access control module, the processor, the user device, and the peer-to-peer device are configured to pair the user device with the peer-to-peer device, use the user device to send an activation command to the peer-to-peer device, store an activation data of the peer-to-peer device on a device ledger, use the user device to send a data command to the peer-to-peer device, and use the peer-to-peer device to send a portion of the user data source to a second device based on the data command. Based on the activation data, the peer-to-peer device rejects commands from all other devices other than the user device.

In another aspect, the present disclosure is directed to a method. The method includes providing a user device and a peer-to-peer device that stores a user data source, pairing the user device with the peer-to-peer device, using the user device to send an activation command to the peer-to-peer device, and storing an activation data of the peer-to-peer device on a device ledger. The method also includes receiving a request data from a second device via one of the user device and the peer-to-peer device, the request data including information requesting a portion of the user data source, using the user device to send a data command to the peer-to-peer device, and using the peer-to-peer device to send the portion of the user data source to the second device based on the data command. The user device is the sole device paired with the peer-to-peer device.

### BRIEF DESCRIPTION OF THE DRAWINGS

Accompanying this written specification is a collection of drawings of exemplary embodiments of the present disclosure. One of ordinary skill in the art would appreciate that these are merely exemplary embodiments, and additional and alternative embodiments may exist and still within the spirit of the disclosure as described herein.

FIG. 1 is a schematic illustration of an exemplary network, in accordance with at least some exemplary embodiments of the present disclosure;

FIG. 2 is a schematic illustration of an exemplary network, in accordance with at least some exemplary embodiments of the present disclosure;

FIG. 3 is a flowchart illustrating an exemplary method, in accordance with at least some exemplary embodiments of the present disclosure;

FIG. 4 is a schematic illustration of an exemplary autonomous system, in accordance with at least some exemplary embodiments of the present disclosure;

FIG. 5 is a flowchart illustrating an exemplary method, in accordance with at least some exemplary embodiments of the present disclosure;

FIG. 6 is a flowchart illustrating an exemplary method, in accordance with at least some exemplary embodiments of the present disclosure;

FIG. 7 is a flowchart illustrating an exemplary method, in accordance with at least some exemplary embodiments of the present disclosure;

FIG. 8 is a flowchart illustrating an exemplary method, in accordance with at least some exemplary embodiments of the present disclosure;

FIG. 9 is a flowchart illustrating an exemplary method, in accordance with at least some exemplary embodiments of the present disclosure;

FIG. 10 is a schematic illustration of an exemplary computing device, in accordance with at least some exemplary embodiments of the present disclosure;

FIG. 11 is a schematic illustration of an exemplary network, in accordance with at least some exemplary embodiments of the present disclosure; and

FIG. 12 is an illustration of exemplary data fields, in accordance with at least some exemplary embodiments of the present disclosure.

### DETAILED DESCRIPTION AND INDUSTRIAL APPLICABILITY

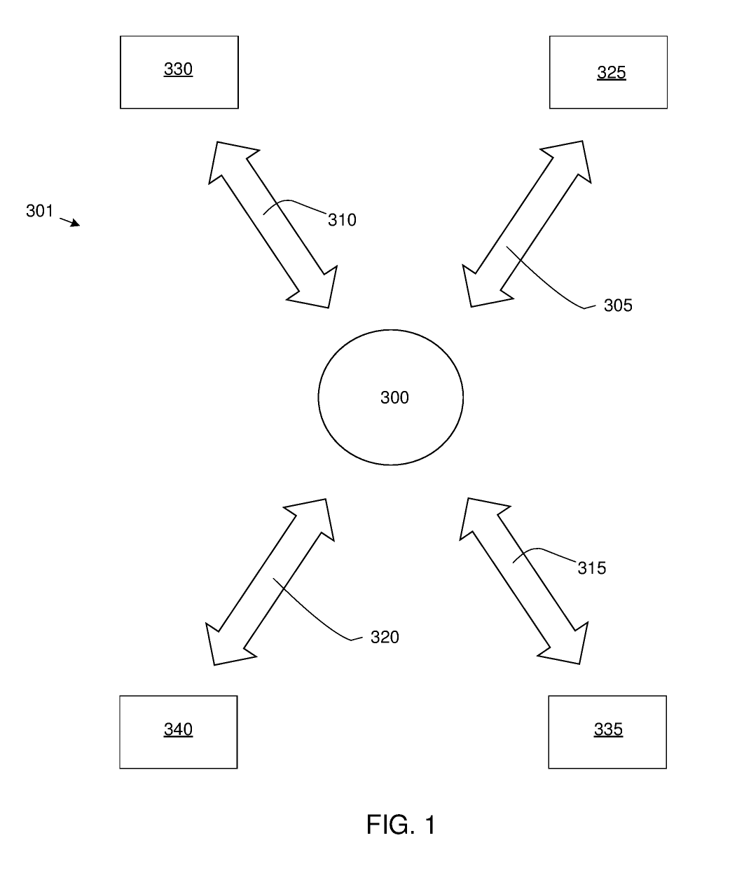

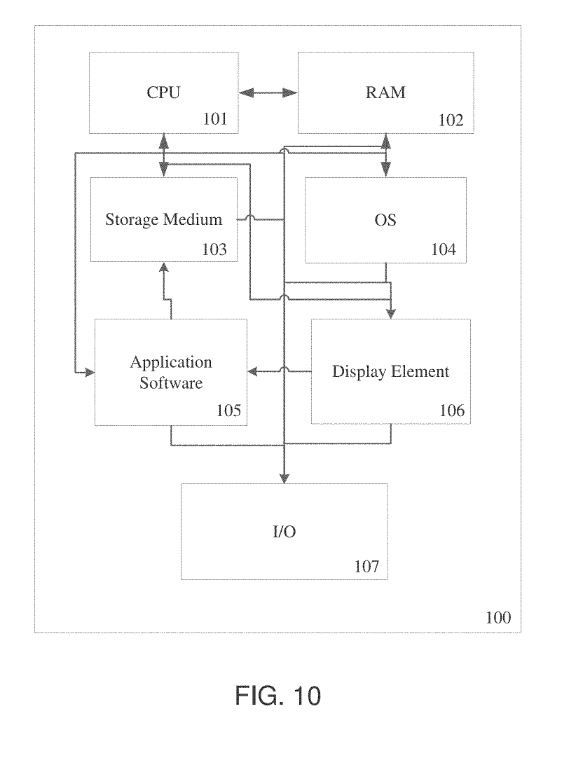

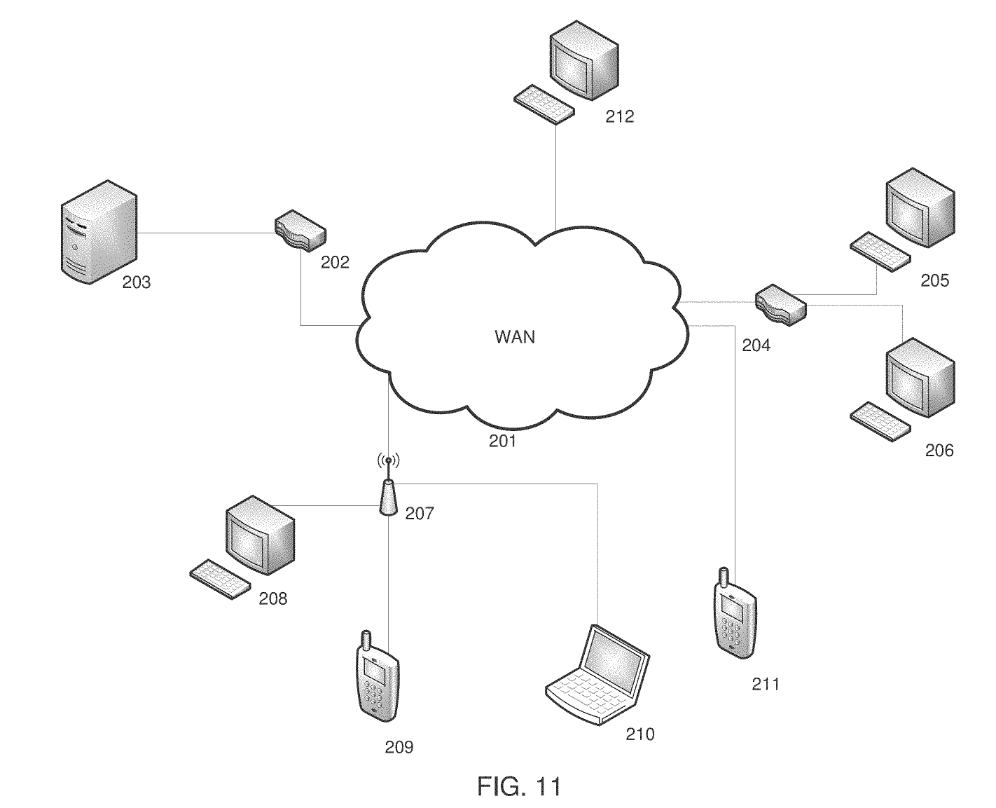

FIG. 1 illustrates an exemplary embodiment of a network 301 that may include components that are similar to those described below in relation to FIG. 10 and FIG. 11, such as for example, components of one or more computing devices and/or components of one or more networks. Network 301 may be an automated system that provides for an interconnected marketplace such as, for example, an automated ecosphere (e.g., a virtual marketplace). Network 301 may be an automated or computer network including a plurality of nodes associated with entities such as, for example, a plurality of users, enterprises, customers, businesses, and/or service providers.

Network 301 may include a node 300. Node 300 may include, for example, an individual user (e.g., or an organizational user). It is also contemplated that node 300 may include computing devices and/or network components associated with an individual user. For example, node 300 may be associated with an individual user having a computing device and/or P2P device (e.g., as described below) that may be part of network 301. Network 301 may for example be a Lens Network and/or peer-to-peer network as described below. It is also contemplated that node 300 may be associated with a business association or any other suitable entity that may engage in personal or commercial activity in a marketplace such as an ecosphere. Node 300 may be associated with ownership of data that may be valuable to other entities using network 301.

Node 300 may include any suitable user interface for receiving input and/or providing output (e.g., any suitable data as described for example herein) to a user. The exemplary user interface may be, for example, a touchscreen device (e.g., of a smartphone, a tablet, a smartboard, and/or any suitable computer device), a computer keyboard and monitor (e.g., desktop or laptop), an audio-based device for entering input and/or receiving output via sound, a tactile-based device for entering input and receiving output based on touch or feel, a dedicated user interface designed to work specifically with other components of the exemplary system, and/or any other suitable user interface (e.g., including components and/or configured to work with components described below). For example, an exemplary user interface of node 300 may include a touchscreen device of a smartphone or handheld tablet. For example, the exemplary user interface may include a display (e.g., a computing device display, a touchscreen display, and/or any other suitable type of display) that may provide data to a user. For example, the exemplary display may include a graphical user interface to facilitate entry of input by a user and/or receiving output.

In at least some exemplary embodiments, node 300 (e.g., or any other suitable portion of the exemplary system) may include any suitable device for allowing network transactions by a user. For example, node 300 (e.g., or any other suitable portion of the exemplary system) may include any suitable peer-to-peer (e.g., “P2P” or “Lumen”) device. The exemplary peer-to-peer (e.g., “P2P” or “Lumen”) device may be an internet-enabled device that acts as a personal data server on a peer-to-peer network, and that facilitates (e.g., substantially all) network transactions on a user's behalf. The exemplary peer-to-peer (e.g., “P2P” or “Lumen”) device may be any suitable computing device as described for example herein. For example, the exemplary peer-to-peer (e.g., “P2P” or “Lumen”) device may be a Raspberry Pi device. The exemplary peer-to-peer (e.g., “P2P” or “Lumen”) device may be used to send and receive data from other peers on the network. Data may be secure and private by default, and may not be shared unless a user explicitly gives access to such data. The exemplary peer-to-peer (e.g., “P2P” or “Lumen”) device may act as a given user's identity on the exemplary system. For example, there may be a one-to-one (e.g., “1-1”) relationship between an identity of a user (e.g., an individual or other entity) and an active peer-to-peer (e.g., “P2P” or “Lumen”) device. Multiple peer-to-peer (e.g., “P2P” or “Lumen”) devices may be utilized to back up an original peer-to-peer (e.g., “P2P” or “Lumen”) device, but a single device (having a one-to-one relationship with a given identity) may be active on the exemplary system (e.g., network) at a given time (e.g., which may help to make an identity of a given user singular). In at least some exemplary embodiments, a user identity may be maintained by a set of keys stored on the exemplary peer-to-peer (e.g., “P2P” or “Lumen”) device that may be included in node 300. These exemplary keys may be used to sign messages sent to other peer-to-peer (e.g., “P2P” or “Lumen”) devices and/or for communicating with any suitable computing device (e.g., mobile device or any other suitable computing device described herein). For example based on an operation of the exemplary peer-to-peer (e.g., “P2P” or “Lumen”) device, node 300 may “peer” other entities (e.g., other individuals or entities) on the exemplary network, as well as other data sets that have been accessed by a given user.

In at least some exemplary embodiments, the exemplary peer-to-peer (e.g., “P2P” or “Lumen”) device may be hardware that operates at a periphery (e.g., “lives” at the “edge”) of a network. For example, the exemplary peer-to-peer (e.g., “P2P” or “Lumen”) device may be an edge computing device. The exemplary peer-to-peer (e.g., “P2P” or “Lumen”) device may serve several purposes on an exemplary Lens network, including for example purposes involving security, data caching, and/or identity. The device may be any suitable device that may run software such as Nodejs. For example, the exemplary peer-to-peer (e.g., “P2P” or “Lumen”) device may be a Raspberry Pi device.

In at least some exemplary embodiments, the exemplary peer-to-peer (e.g., “P2P” or “Lumen”) device may serve as a first layer of security around data, and may for example store and encrypt data that it creates. The exemplary peer-to-peer (e.g., “P2P” or “Lumen”) device may include a built-in elliptic curve cryptography (e.g., provided by a minimal version of the libsodium project) so that data may stay secured at rest. It is also contemplated that a physically unclonable function (PUF) may be included, which may make decryption by an attacker difficult even in the case where the physical device is stolen. Also, data may be stored on a hardened operating system that minimizes a number of applications that are running at a given time, and thereby minimizes potential attack vectors using compromised software systems.

In at least some exemplary embodiments, the exemplary peer-to-peer (e.g., “P2P” or “Lumen”) device may serve as an edge caching device. For example, data may be cached at local endpoints, which may make it relatively easier for nearby peers to access the same data (e.g., which may also make scaling datasets such as popular datasets easier in the exemplary P2P network). In at least some exemplary embodiments, instead of fetching data from a server disposed in another geographic area (e.g., on the other side of a country or on another continent), data may be fetched from a peer in close geographic proximity (e.g., within the same neighborhood or a few miles, making the distance that data travel significantly shorter).

In at least some exemplary embodiments, the exemplary peer-to-peer (e.g., “P2P” or “Lumen”) device may provide identity functions on the exemplary network. Exemplary peer-to-peer (e.g., “P2P” or “Lumen”) devices may be recorded in a public ledger, along with the public keys of the respective peer-to-peer (e.g., “P2P” or “Lumen”) devices. This recording may allow for users or third parties to lookup the device owners and also to validate any data that comes from other peers on the exemplary network. For example, identity may be verified as part of an exemplary signup process. For example, the identity function may operate using any suitable “e-residency” model. This may allow the exemplary system to include a formal investigation process of any desired rigor to be added to the ledger for the purposes of determining whether a given peer-to-peer (e.g., “P2P” or “Lumen”) device may be activated on the exemplary network. Once a given peer-to-peer (e.g., “P2P” or “Lumen”) device has been activated, other users of the exemplary network may then trust communication with that device. Accordingly in at least some exemplary embodiments, the exemplary system may avoid identity being solely associated with a public key on a blockchain in which any entity or robot may add themselves to the chain. In at least some exemplary embodiments, anonymous transaction may not take place on the exemplary system.

Node 300 may include stored data. For example, node 300 may include data that is owned by a user, consumer, or enterprise associated with node 300. For example, a single individual may own all data that is associated with node 300 (e.g., the data associated with node 300 is owned by the user associated with node 300, with the data being either stored at node 300 or, for example, controlled from node 300 and stored remotely). The information may for example be stored on a peer-to-peer device associated with node 300. All of the data that is owned by a user or other entity associated with node 300 may comprise a single source of truth of information. For example, this single source of truth of information may be stored (e.g., in a storage container, a self-storage container, or a sphere of information) so that the data is controlled and owned by a user or entity of node 300. The single source of truth of information may include some or substantially all information associated with a user such as, for example, a full name, alias names, past and present address information, phone numbers, email addresses, any suitable contact information, social media information, financial information (e.g., credit card numbers or bank information such as account numbers), credit information, tax return information, a social security number, and/or any other public or private information that a user may provide to other entities such as businesses and service providers.

Network 301 may also include a plurality of nodes 325, 330, 335, and 340 that may each be associated for example with a business association, individual user, or any other suitable entity that may engage in personal or commercial activity in a marketplace such as an ecosphere. Nodes 325, 330, 335, and 340 may be associated with entities that are third parties relative to node 300 such as, for example, third party network service providers such as businesses and/or commercial entities (e.g., business associations) active within network 301. For example, nodes 325, 330, 335, and 340 may be associated with businesses that may benefit from data owned by node 300.

Network 301 may include a plurality of connections 305, 310, 315, and 320 that may connect node 300 respectively to nodes 325, 330, 335, and 340. Connections 305, 310, 315, and 320 may be similar to the connections described below in relation to FIG. 11, and may be any suitable connection for connecting nodes and other components of a network. For example, connections 305, 310, 315, and 320 may transfer communication between the various nodes such as, for example, information requests and any other type of data.

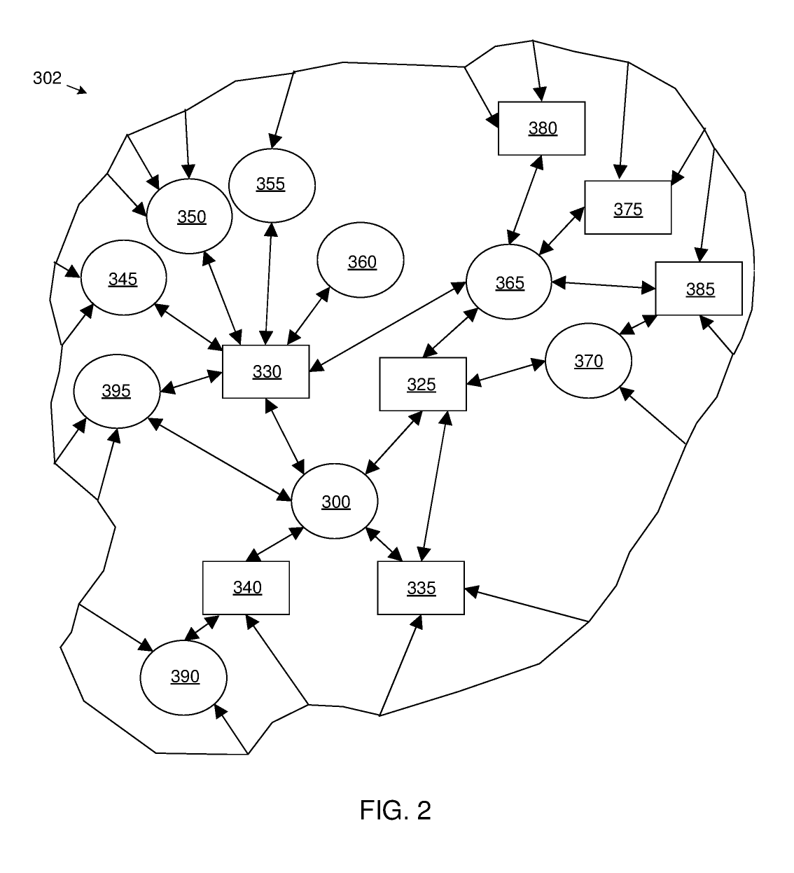

FIG. 2 illustrates an exemplary network 302. Network 302 may be a larger and/or more complex network relative to network 301. For example, network 301 may be a part of the relatively larger network 302. In addition to including components of network 301 disclosed above, network 302 may include nodes 345, 350, 355, 360, 365, 370, 375, 380, 385, 390, and 395 that may be similar to nodes 300, 325, 330, 335, and/or 340, as well as additional nodes. Nodes 345, 350, 355, 360, 365, 370, 375, 380, 385, 390, and 395 may be connected to each other and/or nodes 300, 325, 330, 335, and/or 340 via connections that are similar to connections 305, 310, 315, and 320. For example, node 300 may be a part of network 301 and/or network 302.

As illustrated in FIGS. 1 and 2, networks 301 and 302 may comprise a flipped data model that may flip data, for example relative to node 300. For example, node 300 may be associated with an individual user that is disposed at a central point of a network relative to his or her data. For example, node 300 may be associated with a user that is provided a 360 degree view of that user's network presence or footprint (e.g., digital presence or virtual presence).

The exemplary disclosed system and method may provide a technical solution for an individual (e.g., or other entity, enterprise, or organization) to sell access to his or her information in an open market and to third parties using a subscription and/or asset model. The exemplary disclosed system and method may also provide to a user an ability to maintain a sphere regarding their data and to allow and control third party algorithm transactions that are performed on the data. The exemplary disclosed system and method may allow for results (e.g., from third party algorithm calculations) to be returned to a user instead of giving away data to intended and/or unintended recipients. Quality of data provided to third parties may be improved because a full set of information may be provided. Additionally, a user (e.g., an individual user or an organizational user) may have a single location of data to manage, which may make management of data simpler and more efficient. The exemplary disclosed system and method may also allow for a new market and data exchange to be provided for information that is being sold by individuals to entities that desire such information. The exemplary disclosed system and method may also provide a solution to regulatory issues such as, for example, compliance with the European Union's General Data Protection Regulation.

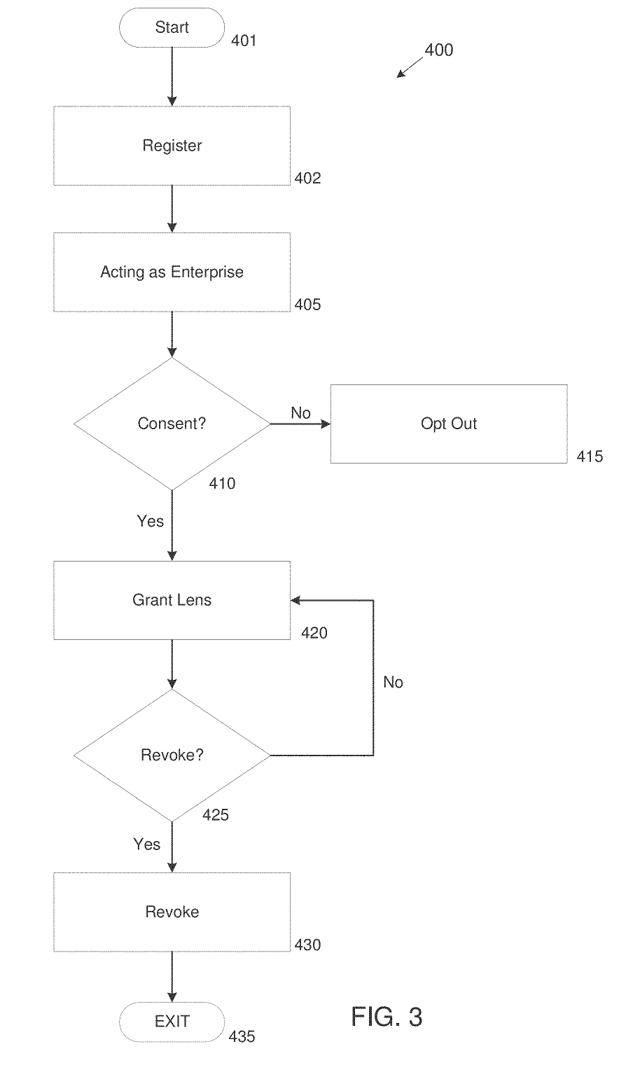

FIG. 3 illustrates an exemplary process 400 associated with the operation of the exemplary networks disclosed above. Process 400 may begin at step 401. At step 402, a user or entity associated with a network node (such as, for example, node 300) may register activity associated with a given node. For example, an individual or entity owning data associated with node 300 may register its participation in the exemplary network (e.g., such as with an applicable governing entity of the exemplary network). For example, a user of node 300 may register the user's identity and provide additional information such as, for example, a business entity of the user. Details of the registration may also include details of the data owned by the user or entity (e.g., information describing the single source of truth of information, data storage container, and/or self-storage container for data owned and/or controlled by a user of node 300). For example, a new company/user registration process that is based on local governing rules or law may be in place, which the user or entity of node 300 may utilize. For example, a registration process may exist that includes revenue, taxation, and other legal rules with which the user is to comply. Also for example, a container may be populated (e.g., initially populated) with existing cloud and/or platform information to establish a single source of truth. For example, an individual user's credentials may be added, e.g., by using existing application program interfaces. Also for example, at least some or substantially all information of an entity may be stored to the container to establish a single source of truth of information.

Upon completing the registration of step 402, a user or entity associated with a node (e.g., an individual user of node 300 or organization associated with a node) may act as an enterprise as shown in step 405. By acting as an enterprise, a user of a node such as an individual user of node 300 may gain a right or power of data portability. For example, because data may be stored and/or controlled by the user (e.g., node 300), data ownership may be registered (e.g., recorded) as belonging to the user. This status may provide the user of a node (e.g., node 300) with data control and/or data provenance over data associated with a node that is registered to the user.

When a user of a node is acting as an enterprise as described above, the user may receive a communication requesting use or access to the user's information as shown in step 410. For example, in step 410, an individual user of node 300 may receive a request from a third party (e.g., from node 325 via connection 305) to use data that is owned and/or controlled by the user of node 300. The user may consider granting the third party permission to access its data. For example, a user (e.g., an individual user of node 300) may use an instrument (e.g., a “Lens”) to help manage, coordinate, and/or control access and/or use of its data by a third party (e.g., node 325). The Lens may comprise, for example, a subscription policy with a mutual agreement that may be used in determining the value of terms and conditions relating to use and access to data.

For example, in environments similar to networks 301 and 302, a user may use an instrument (e.g., the Lens) to have control and awareness of which third parties have access to what data belonging to the user. For example, the Lens may act as a subscription for third parties to view and/or use information (e.g., data owned by an individual and stored in a container associated with node 300) under a suitable meeting of the minds such as, for example, mutual terms and conditions of agreement between an individual user and a third party. A user of a given node (e.g., an individual user of node 300) may give, revoke, re-instate, sell, or donate a Lens to others. This arrangement may allow a user (e.g., an individual) to control access to the user's data (e.g., allow the individual to act as “a person of his or her information”). For example, if a third party (e.g., associated with node 330) desires access to information associated with a user (e.g., an individual user of node 300), the third party may purchase a Lens from the user using a procure-to-pay process or other suitable payment process. For example, the payment process may set up a mutual terms and conditions agreement that provides the user the capability to opt out of automated decisions and/or transactions. The payment process may also provide for setting a value of the Lens (e.g., a value of the Lens relative to a marketplace). Such processes allow a user (e.g., an individual user associated with a node) to act as an enterprise of that user's information. It is contemplated that a clearing corporation model may be used as part of the procure-to-pay process for the lens, which may assist an individual in settling a transaction for a user's data on behalf of the user with third parties.

In at least some exemplary embodiments, the exemplary Lens may provide a user with information regarding (e.g., a “window” into) any suitable dataset. An unlimited number of lenses may be created by the exemplary system and method. The exemplary Lens may for example be a data object that contains information about how the Lens may be viewed. Lenses may be revoked by an owner (e.g., user that is an owner) if the owner of the dataset decides that the data should no longer be shared. Lenses may be encrypted and/or undiscoverable by default. Lenses may be replicated on the exemplary system (e.g., exemplary P2P network as described for example herein) and may allow for scalability (e.g., significant or extreme scalability). In at least some exemplary embodiments, the exemplary Lens may be built on top of a Dat protocol, with the Lens having substantially all of the security features of Dat and including additional layers added by the Lens. In at least some exemplary embodiments, the exemplary Lens may be configured so that other peers (e.g., other peer nodes) on the exemplary system that have viewed a given user's data may help to serve that given user's data to other interested parties as described for example herein.

Based on the above exemplary processes, users may for example be provided with a privacy by default design to allow for example General Data Protection Regulation (GDPR, for example as used in the European Union) consent and compliance between individuals and enterprises. The exemplary Lens described above may allow the individual to act as an enterprise of that user's information, leveraging a single source of truth of information (e.g., a self-storage container). This may provide user with versatile mutual terms and conditions agreements (for example, providing an alternative to “one-way click through” agreements associated with conventional Cloud models), and procure-to-pay processes.

Based on the above exemplary processes, users (e.g., including an individual user of node 300 or an organizational user) may be provided with a set of tools, agreements, and processes to act as a person and an enterprise of his or her information. This may allow for a user such as an individual to interact with a new ecosphere of third parties and allow purchase of subscriptions to information under mutual terms and conditions. This arrangement may, for example, give control and awareness to an individual user in contrast to conventional cloud-based arrangements. It is also contemplated that artificial intelligence may be used in conjunction with the 360 degree view of data described above to assist an individual user in valuating access to his or her data and use of his or her time by various third parties based on the individual user's specific priorities and values.

For example, data science and artificial intelligence may be included in providing a full 360 degree view of an individual's information. For example, artificial intelligence may be used to help a user regarding customer relationship management (e.g., a flipped data model and flipped customer relationship management model associated with the above-described exemplary embodiments) regarding a single source of truth for data owned and/or controlled by the user. For example, an individual may serve as their own customer relationship management entity (e.g., artificial intelligence may assist in this process). For example, artificial intelligence may help individuals maximize their information value and help them, for example, match their time with the appropriate information. For example, as an alternative to individuals joining a loyalty program of third parties such as third party enterprises, the third party enterprises may instead join a loyalty program associated with a user (e.g., an individual user).

In at least some exemplary embodiments, the exemplary disclosed system and method may utilize sophisticated machine learning and/or artificial intelligence techniques to prepare and submit datasets and variables to cloud computing clusters and/or other analytical tools (e.g., predictive analytical tools) which may analyze such data using artificial intelligence neural networks. The exemplary disclosed system may for example include cloud computing clusters performing predictive analysis. For example, the exemplary neural network may include a plurality of input nodes that may be interconnected and/or networked with a plurality of additional and/or other processing nodes to determine a predicted result. Exemplary artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. The exemplary disclosed system may utilize prediction algorithms and approach that may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets.

Based on the above exemplary processes, an ecosphere of third parties may be created (e.g., networks 301 and 302) that may provide an alternative to conventional platforms that harvest and exploit data. For example, an individual (e.g., or an organization such as a business having organizational data) may be placed at the center of that individual's data and in ownership of his or her data, allowing services to follow a versatile procure-to-pay model that focuses on interested parties to a given transaction, thereby removing the middleman role typically associated with conventional platforms. For example, individuals may go directly to other individuals and organizations to enter into commercial transactions and/or obtain services using an instrument such as the above-described exemplary Lens. Instead of for example harvesting information from users, third parties may purchase Lenses or similar data rights to their customers' information. For example, the above exemplary arrangements may be a flipped data model that puts an individual at the center of access to that individual's data (e.g., at the center of the procure-to-pay process of a Lens), setting up mutual terms and conditions and setting a value of a Lens in view of the marketplace. For example, acting as an enterprise, an individual user may control access and use of his or her data, and allow access to that data at a price set according to the discretion of the user in view of the market for purchasing data. For example, the above exemplary processes allows an individual user to negotiate a fair price on the market for access and use of the user's data.

Returning to FIG. 3, a user may receive a request for access to that user's information in step 410. As shown in step 415, the user may choose to opt out by not consenting to provide access or use of its data to a third party. For example, an individual user of node 300 may deny access and/or use of his or her data by node 340, which may for example be a third party service provider offering services to the user of node 300 via connection 320. For example, an individual user of node 300 may exercise a right to opt out of decisions (e.g., automated decisions) associated with offers from a third party. For example, a Lens may carry a mutual terms and conditions policy, giving an individual the option to opt out of any or all decisions associated with third parties desiring access to the individual's data.

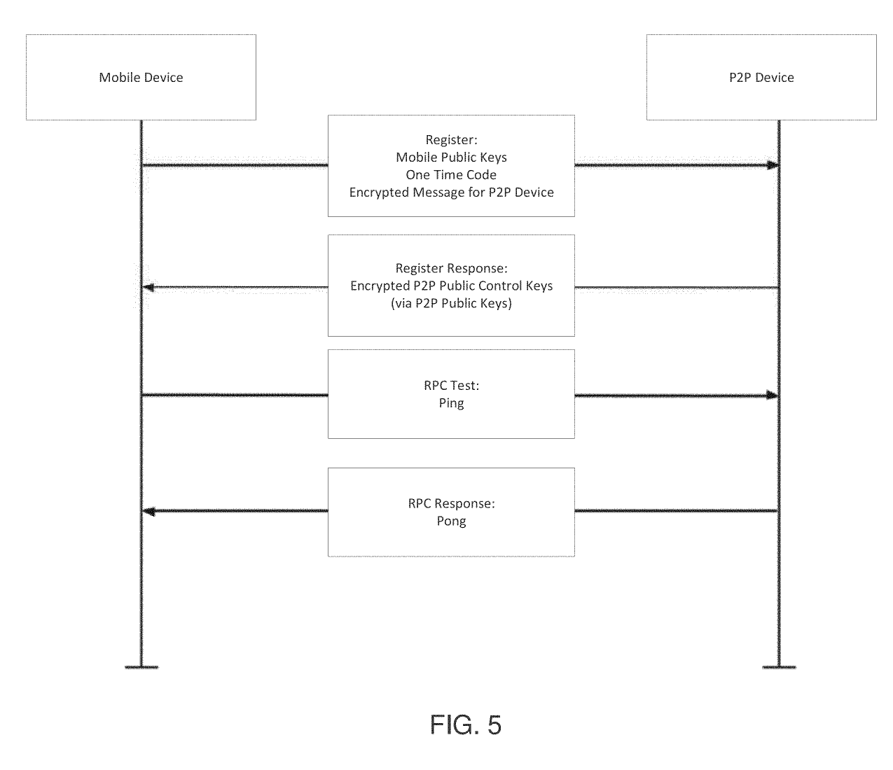

As shown in step 420, an entity of a node (e.g., a user of node 300 or any other node of networks 301 and/or 302) may grant access to data stored in a single source of truth. For example, an individual may approve a Lens and agree to mutual terms and conditions as an enterprise of his or her own information. A third party (e.g., a third party operating through any of nodes 325, 330, 335, or 340) may thereby for example achieve compliance by purchasing a Lens and receiving consent/approval from a user of a node (e.g., an individual enterprise of node 300). Accordingly, the Lens may both satisfy rights and adjustments set out in, for example, GDPR, and also provide new value and a new economy for an individual and his or her information. For example, a peer to peer model is thereby provided along with tools for an individual to interact as an enterprise with third parties who can purchase a Lens to desired information of an individual user. For example, data ownership may be thereby flipped from a platform to an individual. For example, third party enterprises may thereby subscribe to information under a mutual terms and conditions agreement. For example, in order to access data to individuals, the enterprise may purchase a Lens, license, or similar instrument. For example, the price of the Lens may be set by an individual or a market (e.g., or by an individual in view of market trends). Accordingly for example, a solution may be provided that allows an individual to own his or her information, assume control of the use of the data, and determine value of the data (e.g., which may be the price that a third party pays for access to the data). Accordingly, for example, an individual may own all of his or her data, control access to his or her information, and interact with an ecosphere of third parties (e.g., exemplary networks 301 and 302) that subscribe to data by purchasing a Lens. Accordingly, for example, a flipped model (e.g., relative to conventional cloud architecture) may be provided to allow for consent, compliance, and/or rights set out in GDPR. Access to the exemplary Lens may be provided to another device as described for example below regarding FIGS. 5-9, which may also be revoked as described for example below.

Returning to FIG. 3 and as shown in step 425, an entity of a node (e.g., a user of node 300 or any other node of networks 301 and/or 302) may decide to revoke access to data stored in a single source of truth. For example, an entity of a node may revoke access to data for which it had previously granted access to a given third party or user. For example, an entity of node 300 may revoke access to third parties, for example, according to the agreement previously entered into during step 420. Following a decision by a user to revoke access, some or all access to data by a given third party would be stopped in step 430. Accordingly, a right to be forgotten (e.g., a right to revoke a Lens, license, or other suitable instrument) may be provided to an entity of a node (e.g., an individual user of node 300). The exemplary process may end at step 435.

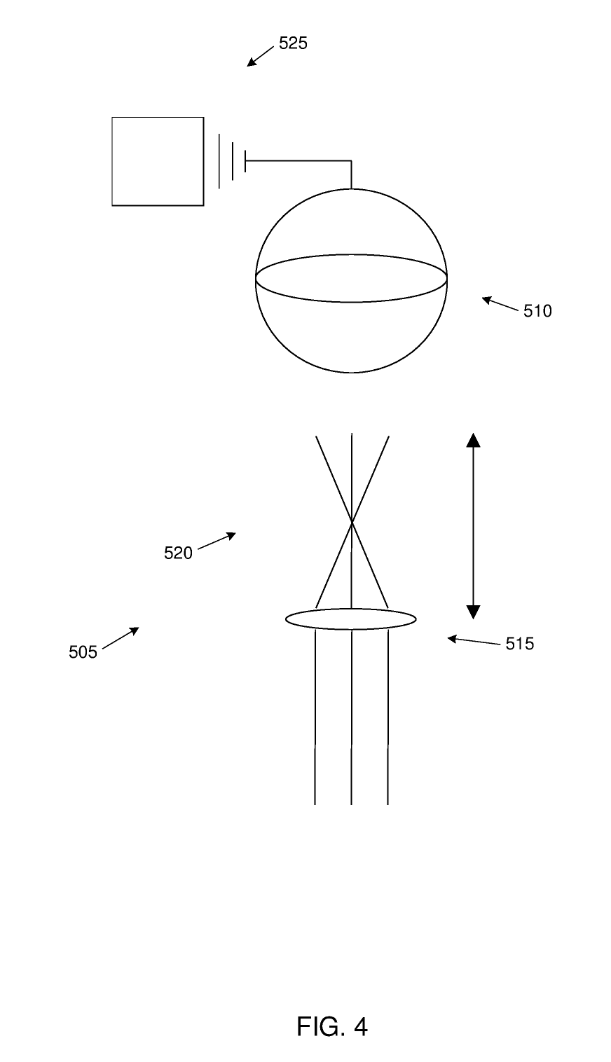

FIG. 4 illustrates an exemplary autonomous system 505 (e.g., an autonomous “vehicle” for a user to act as his or her own enterprise) that may be utilized with a given node of the exemplary system such as, for example, an individual user of node 300. System 505 may be a fully autonomous store for an individual, which may allow a user such as an individual to sell and control access to that user's information. System 505 may include a sphere 510, which may be a container in which a single source of truth of information of the user is stored (e.g., a single data location for containing some or substantially all of a user's data). System 505 may also include a Lens 515, which may be similar to the exemplary Lens discussed above for assisting a user in managing, coordinating, and/or controlling access and/or use of its data by a third party (e.g., node 325). System 505 may also include a lens interface 520 that may provide a suitable interface between sphere 510 and lens 515. For example, lens interface 520 may include an interface component (e.g., a “windshield”) for a user and/or the system to identify and/or focus data for use in Lens 515. Also for example, lens interface 520 may include interface components (e.g., a “focal point” and/or “focal length” 522) to assist the user and/or the system in determining the appropriate level, specificity, and/or amount of data (e.g., data to be transferred or sold to other users) to incorporate into a lens 515 for use with the exemplary system. Sphere 510 may operate with a component 525 and/or other components of the exemplary system. Component 525 may include components described herein for facilitating computer processing including processing of algorithms and other processes, artificial intelligence operations, and other processes of the exemplary system (e.g., may be a “hyperdrive” for processing the data of sphere 510 for use with lens 515).

For example, the “focal point” of lens interface 520 may be an algorithmic and/or computational engine that processes data of sphere 510 that may be accessed via Lens 515. For example, if a user of node 300 would like to access (e.g., “see”) data associated with other third party nodes (e.g., if the user of node 300 would like to see data such as pictures associated with nodes 335 and 340, which may be for example friends of the user of node 300), the user of node 300 may execute a focal point (e.g., a particular focal point of available focal points of system 505), which may query one or more lenses that the user of node 300 may have received from users of nodes 335 and 340 (for example, the user of node 300 may query lenses of nodes 335 and 340 to ascertain if new data such as new pictures are available or whether data has been updated). Based on these queries, a data feed may result, which the user of node 300 may view via his or her interface component (e.g., “windshield”). Accordingly, the exemplary system and method may provide a technique for controlling access to personal data between third parties such as friends and family, in addition to controlling access desired by third party commercial entities.

For example, the “focal points” of lens interface 520 (e.g., one or more focal points associated with the nodes of the exemplary system) may serve as applications for utilization by users (e.g., such as individual users and/or commercial third party entities). In the exemplary flipped data model illustrated for example in FIGS. 1 and 2 that may provide an exemplary ecosphere, a given “focal point” may be (e.g., selectively) decoupled from data of sphere 510. Accordingly, data and applications may not be joined in a single platform. In the exemplary system and method (e.g., the exemplary flipped data model illustrated for example in FIGS. 1 and 2), applications (e.g., “focal points” of lens interfaces 520 of a given node) may access data of sphere 510 using corresponding Lens 515 of a given node. This exemplary flipped model accordingly may not involve a configuration in which data and applications are joined together.

For example, system 505 may provide a system (e.g., a “vehicle”) for a user to interact without for example using a system in which data and applications are joined together. For example, system 505 may allow an individual user to act substantially autonomously in an ecosphere (e.g., a peer-to-peer ecosphere). For example, system 505 may provide a user with a technique for storing some or all of his or her data and a technique (e.g., “focal points”) for controlling access and distribution of the data. For example, system 505 may be a turn-key (e.g., ready to be operated) system that may be provided to a user (e.g., purchased by an individual) to allow the user to autonomously interact in an ecosphere (e.g., interact with service providers and/or friends and family) while controlling access to his or her data. For example, system 505 may allow a user to obtain services from third parties and interact with personal contacts without giving away personal data and opportunity as described herein in at least some exemplary embodiments.

In at least some exemplary embodiments, the exemplary disclosed system and method may put a content creator in substantially full ownership of that content creator's content. The exemplary system and method may provide a network that frees services from having explicit ownership of users' data and allows users to exercise control of their data by revoking access when desired. A number of centralized services used in the system may be minimized to minimize cost to an enterprise (e.g., a individual or a company), provide suitable scalability, and/or place ownership and/or responsibility on end-users for hosting their own data. Users may host their data on a small computing device (e.g., CPU device) that is designed to be connected to the internet and may perform data transactions. These transactions may be controlled by a user through the user's computing device (e.g., mobile device or any other suitable computing device described herein), which may be paired directly to the user's P2P device.

In at least some exemplary embodiments, the exemplary disclosed system and method may allow users to share subscriptions to data, and/or have identity on an exemplary network (e.g., an identity may be maintained in a centralized system that may verify users who enter the network). The exemplary disclosed system and method may allow users to share data securely and privately with services or individuals of their choosing, for example without a middleman to observe a user's data. Data may be end-to-end encrypted. A user may revoke access to that user's data if the user is no longer interested in sharing data (e.g., by using tools built around a Lens as described for example herein). The exemplary disclosed system and method may provide users with explicit control of their data via an exemplary device designed to host and replicate data on a peer-to-peer network as described for example herein. Data may thereby be owned and controlled by an originator of that data. The implementation of lenses (e.g., via data) may substantially prevent data from being altered by anyone and/or any entity other than an originator of a given dataset.

In at least some exemplary embodiments, the exemplary disclosed system and method may include a Lens Network (e.g., Networks 301 or 302) that may enforce identity of users and may provide users with a technique for validating identity. The Lens Network may be for example any suitable network for example as described herein that computing devices (e.g., mobile devices or any other suitable device as described for example herein) may use to communicate and on which to operate. The exemplary disclosed system and method may facilitate proxy connections between peer-to-peer (e.g., “P2P” or “Lumen”) devices, computing devices (e.g., mobile devices), and/or any other suitable computing devices. The exemplary disclosed system and method may provide public key and/or private key infrastructure for communication between devices on the exemplary system (e.g., network). The exemplary disclosed system and method may also provide a centralized ledger to keep track of some or substantially all peer-to-peer (e.g., “P2P” or “Lumen”) devices issued to users. The exemplary disclosed system and method may provide a Lens infrastructure that may be designed to give users identity, control of their respective data, end-to-end encryption, and/or privacy by default. The exemplary architecture may also include application program interfaces (“API”) that may allow future development of services for leveraging a data network that may be subscription-driven. A given peer-to-peer (e.g., “P2P” or “Lumen”) device may include a single source of truth (e.g., as described above) for a given user.

In at least some exemplary embodiments, the exemplary disclosed system and method may provide for suitable identity measures regarding how transactions are made on the exemplary Lens network. For example, the exemplary system and method may substantially block anonymous and/or semi-anonymous transactions. The exemplary system may provide for accountability on the network regarding how data is used and distributed, which may prevent illicit activities from being performed on the exemplary system such as black market activities and other activities that may subvert the law of a given jurisdiction.

In at least some exemplary embodiments, a central authority component (e.g., ledger) may be included in the exemplary system to verify the identities of prospective Lens network users. The exemplary authority component (e.g., a device ledger) may maintain a database of some or substantially all legitimate identities on the Lens network and may operate to add and/or subtract these entries. The authority component (e.g., a device ledger) may use any suitable techniques to validate the identity of a given individual or entity before granting that individual or entity access to the database. Exemplary techniques for validating identity may include an extensive (e.g., or partial) investigation into an individual, prompting a user to click a link in an email, and/or any other suitable technique for verifying identity. It is contemplated that the exemplary authority component may be included entirely or partially as part of the exemplary system and/or may be entirely or partially included in a system that is separate from the exemplary system.

In at least some exemplary embodiments, an exemplary device ledger may provide a level of trust between individuals on the network and entities (e.g., businesses) that desire to validate an identity of any individual or entity (e.g., service provider) that is active on the exemplary network. If a Lens user is legitimate (e.g., the exemplary system has verified an identity of the user), that user may have their digital signature verified by anyone in the network. In at least some exemplary embodiments, this centralized data (e.g., data of the device ledger) may be partially or completely public. For example, identity data may be public on the exemplary system, while authorization and authentication may be performed using a given user's secret keys.

In at least some exemplary embodiments, the exemplary device ledger may publish a user public key, a user full name, and/or a unique identification number for each user. The exemplary system may provide a plurality of (e.g., two or more) public keys, including a first public key for encrypting messages and a second public key for validating signatures. The user names may be made public so that other users or services using the network may look up another user by that user's name and/or use a given user's public key to send Lenses to that user and/or to validate messages that are received from that user. Once a given user has been added to the exemplary device ledger, that user may have authorization to change that user's keys at any time (e.g., to a valid set of keys) and/or to delete that user's data from the ledger. Also for example, users may not be able to change their unique identification numbers and/or read themselves to the ledger.

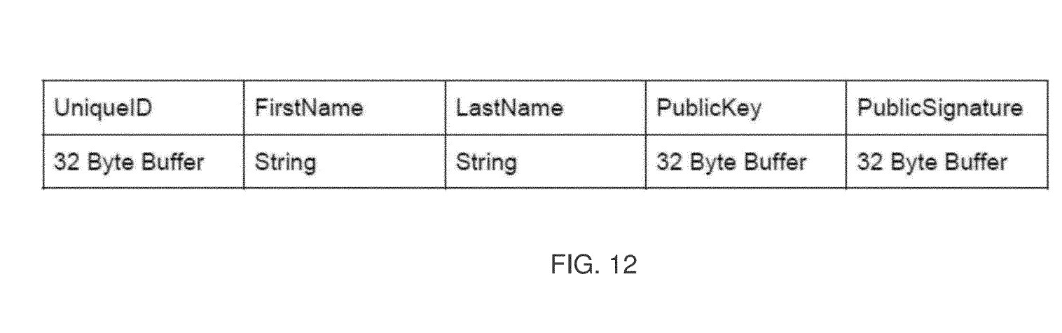

FIG. 12 illustrates exemplary data fields and data types that may be stored publicly in the exemplary device ledger. Users of the exemplary network may use this exemplary data to validate each other and/or provide end-to-end encrypted communication with one another.

In at least some exemplary embodiments and as illustrated in FIG. 5, a connection between a computing device (e.g., mobile device or any other suitable computing device described herein) and a P2P device for a given user may be facilitated through an exemplary Lens Network and/or an exemplary P2P network. Some or substantially all of the exemplary Lens Network and exemplary P2P network may be integrated into the same network or may be separate networks. FIG. 5 for example illustrates how pairing may be performed between a user's computing device (e.g., mobile device or any other suitable computing device described for example herein) and the user's P2P device, with an exemplary timeline moving from a top of the illustration to a bottom of the illustration. Each P2P device (e.g., that is manufactured) may be preloaded with its own public and private keys, a serial number, a one-time discovery code, and/or an activation code. The public key, the serial number, the one-time discovery code, and/or the activation code may be stored in the Lens Network database. The private and/or public keys may also be stored on the P2P device itself. The private keys may not be stored on the Lens network, but may be stored on the P2P device of a given user. The public keys may serve as a mechanism on the P2P network for other peer-to-peer devices or services to look up whether a particular message is coming from a legitimate user on the Lens Network. If the public keys are not found in the Lens ledger, then a particular peer may ignore the message without further processing. Additionally, each message may be verified to be authentic by verifying the signature that accompanies each message that is sent on the Lens network.

In at least some exemplary embodiments, when a given peer-to-peer device is delivered to a given user, it may be shipped with a barcode (e.g., matrix bar code such as a QR code) that may be used with an application (e.g., API) to create a pairing between a user's peer-to-peer device and the user's computing device (e.g., mobile device or any other suitable computing device described herein). The exemplary barcode (e.g., QR code) may contain the peer-to-peer (“P2P”) device's serial number, the one-time discovery code, and/or the device's public key. Based on this information, the pairing processes between the user's P2P device and the user's computing device (e.g., mobile device or any other suitable computing device described herein) may begin.

Once a user has connected their device to the internet (e.g., via an ethernet connection or any other suitable connection), the user may be prepared to download an application associated with the system (e.g., application that may include an API). Once downloaded and started, the application may create its own set of public and private keys. These keys may be stored on the user's computing device (e.g., mobile device or any other suitable computing device described for example herein), and may not be stored in other locations (e.g., may not be stored on the Lens network). These keys may be used to establish a connection with the peer-to-peer device. Next, the user may be prompted to take a picture of the barcode (e.g., QR code) and/or scan the barcode that is associated with (e.g., that was shipped with) the user's P2P Device. For example, the user may take a picture of the barcode or scan the barcode using a computing device such as a mobile device. Using the one-time discovery code, the user's computing device (e.g., mobile device or any other suitable computing device described for example herein) may encrypt a message (e.g., a ‘register’ message) encrypted for the P2P device.

When the user's P2P device receives a register message with the one-time code, the user's P2P device may whitelist the keys from the user's computing device (e.g., computing device such as a mobile client) and may send back “control” public keys to the user's computing device (e.g., mobile device or any other suitable computing device described for example herein). The control public keys may be stored (e.g., recorded) on the P2P device and may not be stored in other locations. These may be the keys that the user's computing device (e.g., mobile device or any other suitable computing device described for example herein) may use to send remote protocol commands to the P2P device. Any other device (e.g., device on the Lens Network) that attempts to send commands to the P2P device may be denied access by the exemplary system.

In at least some exemplary embodiments, a single computing device (e.g., mobile device or any other suitable computing device described for example herein) may be allowed to control a given paired P2P device at a given time. It is also contemplated that a plurality of computing devices may be given access to a given P2P device as well. Once registration is completed, a given user's computing device (e.g., mobile device or any other suitable computing device described for example herein) may be configured to send a variety of remote protocol commands (RPCs) to the paired P2P device. Exemplary commands (e.g., RPCs) may include an “Activate” command, a “Ping” command, a “createLens” command, a “getLens” command, a “getLenses” command, a “shareLens” command, and/or any other desired command. The exemplary “Activate” command may allow the user to either choose to participate in the Lens network or some other trusted identity management and public and/or private key infrastructure (e.g., this RPC may specifically activate the P2P Device on the Lens network). The exemplary “Ping” command may be used to validate connections between the computing device (e.g., mobile device or any other suitable computing device described for example herein) and the P2P device, and/or as a “heartbeat” to make sure a persistent connection may be maintained. The exemplary “createLens” may create an arbitrary dataset on the P2P device that may include contact information or any other suitable text data that may be created and stored privately on the P2P device (e.g., entities other than the user's paired computing device may not view this data). The exemplary “getLens” command may be used to retrieve a specific dataset that the user has already created on the P2P device. The exemplary “getLenses” command may retrieve all of the datasets that have been created on the P2P device. The exemplary “shareLens” command may encrypt and send a lens to another computing device or service (e.g., via the P2P network).

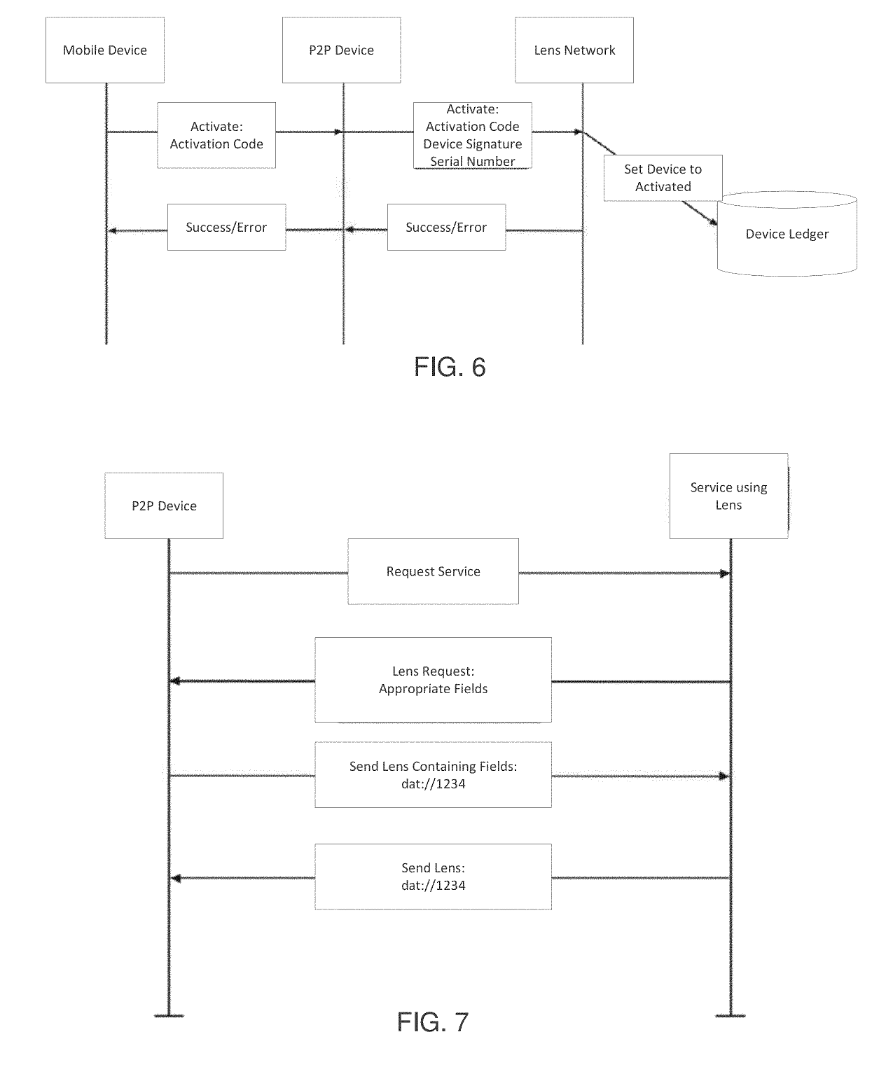

In at least some exemplary embodiments and as illustrated in FIG. 6, the exemplary system and method may provide for activation on the exemplary Lens Network. For example, FIG. 6 illustrates how activation may be performed, starting from an exemplary user's computing device (e.g., mobile device or any other suitable computing device described for example herein) and eventually changing a state of data of the exemplary device ledger. When a user (e.g., owner) of a given P2P device desires to subscribe to data that other individuals own and/or desires to share data of their own that is not considered public, that user's P2P device may interact with the exemplary Lens Network. The first step for being able to interact with the Lens network may be to activate the P2P device. Prior to activation, the P2P device may respond to RPCs received from the paired mobile device, but may neither receive nor send lenses. An activated P2P device (e.g., a P2P device to which a user has successfully connected) may allow administrators (e.g., owners) of the exemplary Lens Network to validate the user's identity and to allow that user to participate in transactions on the Lens Network.

In at least some exemplary embodiments, a plurality of security measures may be put in place to help make activation secure. One security measure may be that activation may be done by a P2P device, and may not be done using other devices. The activation step may be an RPC call made from a user's computing device (e.g., mobile device or any other suitable computing device described for example herein) and then sent to an exemplary endpoint has been deployed in a centralized infrastructure. That exemplary endpoint may validate that the message was signed by a valid P2P device (e.g., that the device's public keys exist on the ledger of devices). Another security measure may be that the end user sends the activation code that is shipped with the P2P device. This may help ensure that a given P2P device may not be activated unless a user of that P2P device has received the activation code for the P2P device.

In at least some exemplary embodiments, once the activation step is completed, the P2P device may be ready to begin sharing and receiving Lenses from other users on the exemplary network. Activation may allow the P2P device to query the ledger for information regarding how to send a Lens to another P2P device or whether or not a Lens received is valid and may be trusted. For example, if a given P2P device is not activated, the exemplary network may deny the query, which may block the P2P device from sending encrypted messages. Additionally, if a user wishes to use an activated P2P device to send a Lens to a P2P device that is not activated, the activated P2P device will not be able to obtain the inactive P2P device's public key in order to encrypt and send information.

In at least some exemplary embodiments and as illustrated in FIG. 7, the exemplary system and method may provide transactions such as Lens transactions. For example, FIG. 7 illustrates an interaction between a service (e.g., service using the exemplary Lens, which provides information that may be subscribed to in order to render service). For example, one or more Lenses may be at a core of the exemplary Lens Network.

In at least some exemplary embodiments, a Lens may be any suitable object (e.g., a JSON object) that may reside in a Dat URL with one or more (e.g., a few) extra pieces of functionality specifically related to the Lens. Dat may provide the functionality to host data on a peer-to-peer network with a link that may not be determined (e.g., an unguessable link). To find data on the Lens Network, a user is given the Dat URL. The user may not find data without the Dat URL. The data may be modified by the originator of the data, and may not be modified by others. Even if another device has access to the Dat URL, that device may view but may not modify the data. The Lens Network may add another layer on top of Dat by allowing users to enforce policy around the data and to also add a layer of encryption on the data so that access may be revoked by removing the data from the URL and/or encrypting (e.g., re-encrypting) the data such that parties that are not authorized to have access to the data may no longer view the contents of the data.

In at least some exemplary embodiments, a plurality of messages may be supported for making transactions. The first message may be a “Lens request.” If a user of a first P2P device desires to request a subscription to a second P2P device to access owner's data, the user (e.g., via the first P2P device) sends the user associated with the second P2P device a Lens request. This message may be sent over a DHT, to a public channel that the second P2P device may be in communication with (e.g., listening on). The message may be transferred via encryption (e.g., via encryption specific for that P2P device) and may contain metadata about what information is being requested. The owner of the second P2P device may choose to fulfil the request, ignore the request, or reject the request.

When the second P2P device owner accepts a Lens request message, another type of transaction that may occur on the network may be a “Send Lens” transaction. “Send Lens” may be an encrypted message sent to another P2P device that contains a Dat URL. The recipient (e.g., user of the first P2P device) may then decrypt the message and the contents inside of the Dat URL, which may ultimately reveal the information that was shared with the recipient. Once opened, the information may not be sent to a database and/or a stored to disk. The data actually stored may be a pointer to the original dataset so that the owner of that information (e.g., the owner of the second P2P device) can update it and delete it as desired. A “Lens Request” may or may not be a prerequisite to issuing a “Send Lens” message (e.g., sending a “Send Lens” may be done independently of any prior state of the P2P device).

In at least some exemplary embodiments, in order to suitably integrate with suitable services for utilizing the exemplary system and method, a “request service” message may be used. For example, this message may be used if a P2P device owner desires to use a given service, and that service operates based on some information provided by that user. As illustrated in FIG. 7, the user may initiate the transaction with a “request service” message. The service may then respond with a “Lens Request” and finally, the user may send a “Send Lens” message to the service and the service may or may not respond with a Lens of its own. For example, as a result, data created by the service may be shared and updated by the user via a Lens and data that the service uses during its operation may be shared and/or updated by the user.

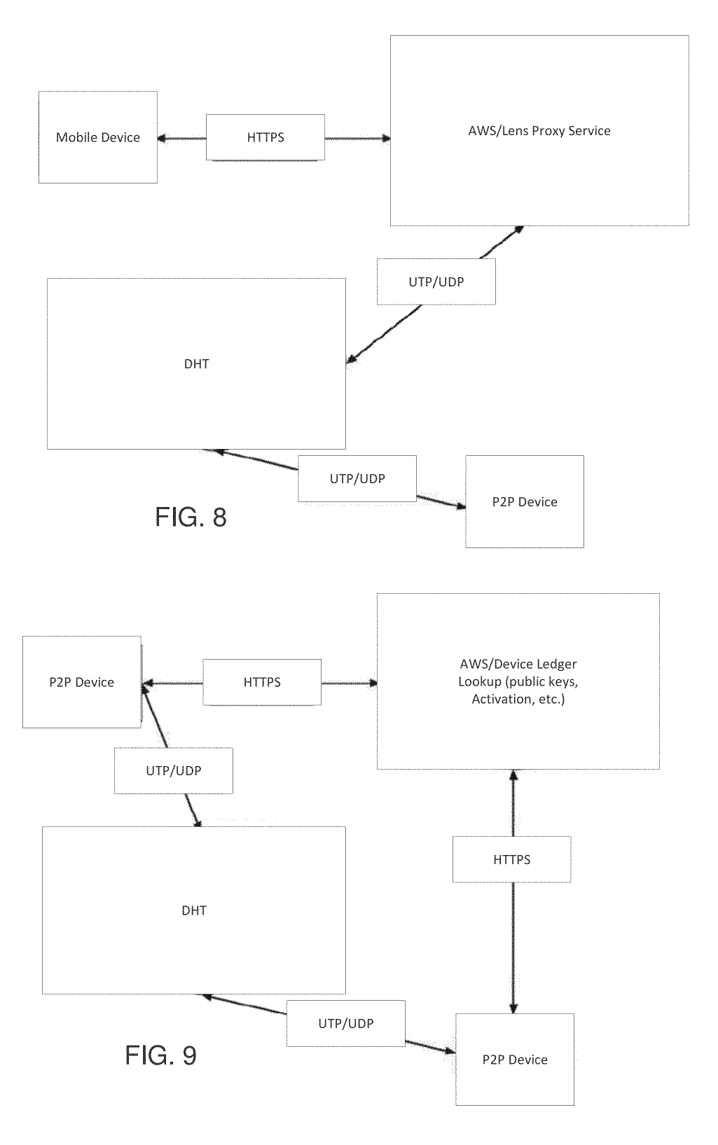

In at least some exemplary embodiments and as illustrated in FIGS. 8 and 9, the exemplary system and method may provide an exemplary architecture for facilitating communication between nodes, devices, and other exemplary components. The exemplary Lens Network may minimize centralized services, which may make scaling the network relatively easier (e.g., which may be beneficial for a community of users utilizing the exemplary system). In at least some exemplary embodiments, some, most, or substantially all communication may be between one or more computing devices (e.g., mobile devices or any other suitable computing devices described for example herein) and one or more P2P devices and services. The communication may be facilitated through implementations of a distributed hash table (DHT) such as, for example, the Kademlia DHT. The exemplary system and method may use tools that are created by the Beaker Browser and DatProject communities to facilitate both RPC calls and messages sent between P2P devices. In order to help with reliability and also quick lookups for identity management on the exemplary ledger, the exemplary system and method may use any suitable software deployments (e.g., Amazon Web Services or any other suitable software).

In at least some exemplary embodiments, communication between a given mobile device and P2P device may use both centralized infrastructure and peer-to-peer infrastructure to facilitate communication. In order to simplify the code involved with communication with the P2P device on the mobile device, HTTPS or any other suitable protocol may be used. First, an HTTPS message containing information to communicate with the P2P device may be sent to a proxy function maintained by the exemplary system. This proxy function may provide for connecting to the Kademlia DHT to ultimately forward the message to the P2P device. The message payloads may be substantially entirely encrypted to facilitate proxy connections. The exemplary system may select suitable channels to facilitate communication, independent of the contents or substance of the data being transferred (e.g., the data may be substantially completely opaque to the system).

FIG. 8 illustrates how connections may be made between a user's computing device (e.g., mobile device or any other suitable computing device described for example herein) and the user's P2P device. Some or substantially all data transferred may be end-to-end encrypted (e.g., it may be encrypted at the mobile device and not decrypted until it reaches the P2P device). The connection between the P2P device and other devices and/or services on the network may also be similarly made, with an exemplary difference being that there may be no proxy service involved and there may be the addition of the PKI system to manage identity and authorization on the network. Some or substantially all communication done between P2P devices may be done over the DHT, and keys may be fetched from the centralized infrastructure that contains the device ledger.

FIG. 9 illustrates how P2P connections may be made (e.g., connections between P2P devices). Public keys may be looked up and verified in the centralized service in any suitable web service (e.g., Amazon Web Services), and the messages may be encrypted and verified.

In at least some exemplary embodiments, the exemplary system and method may put control of data ownership in the hands of the originator of that data. The exemplary Lens Network allows users to verify the identity of other users, share data with other users securely and privately, and allows users to revoke data and data access from subscribing parties. The exemplary system and method may use a minimal centralized infrastructure to provide users some of the many benefits of P2P such as scaling, redundancy and leveraging unused computer power. In at least some exemplary embodiments, the exemplary network may be divided into different categories such as arbitrary scalable message passing, public/private key infrastructure, and/or any other suitable category.

In at least some exemplary embodiments, the exemplary disclosed system may include a data access control module, comprising computer-executable code stored in non-volatile memory, a processor, a user device, and a peer-to-peer device that stores a user data source. The data access control module, the processor, the user device, and the peer-to-peer device may be configured to pair the user device with the peer-to-peer device, use the user device to send an activation command to the peer-to-peer device, store an activation data of the peer-to-peer device on a device ledger, use the user device to send a data command to the peer-to-peer device, and use the peer-to-peer device to send a portion of the user data source to a second device based on the data command. Based on the activation data, the peer-to-peer device may reject commands from all other devices other than the user device. The peer-to-peer device may have a storage medium including information selected from the group consisting of a public key, a private key, a serial number, a one-time discovery code, and an activation code. The activation data of the peer-to-peer device stored on the device ledger may be a public key. The public key may verify an identity of a user of the peer-to-peer device, which is the same identity and the same user as the user device. The peer-to-peer device may include a barcode. Pairing the user device with the peer-to-peer device may include using the user device to scan the barcode that includes information selected from the group consisting of a serial number of the peer-to-peer device, a one-time discovery code, and the activation data that is a public key. Pairing the user device with the peer-to-peer device may include storing a key data on a local storage of the user device, the local storage being a non-network storage (e.g., a storage that may not communicate with other devices or components via a network). The user data source may be a single source of truth of information of a sole user of the peer-to-peer device, who may also be the sole user of the user device. The sole user may solely control data of the user data source. The data access control module, the processor, the user device, and the peer-to-peer device may be configured to use the user device to send a revocation command to the peer-to-peer device to revoke access by the second device to the portion of the user data source.

In at least some exemplary embodiments, the exemplary disclosed method may include providing a user device and a peer-to-peer device that stores a user data source, pairing the user device with the peer-to-peer device, using the user device to send an activation command to the peer-to-peer device, and storing an activation data of the peer-to-peer device on a device ledger. The exemplary disclosed method may also include receiving a request data from a second device via one of the user device and the peer-to-peer device, the request data including information requesting a portion of the user data source, using the user device to send a data command to the peer-to-peer device, and using the peer-to-peer device to send the portion of the user data source to the second device based on the data command. The user device may be the sole device paired with the peer-to-peer device. The second device may be selected from the group consisting of a second peer-to-peer device, a second user device, and a cloud-based service. The request data may include information requesting a subscription to the portion of the user data source. The exemplary disclosed method may further include using the user device to send a revocation command to the peer-to-peer device to revoke the subscription to the portion of the user data source. Receiving the request data from the second device via one of the user device and the peer-to-peer device may include receiving a message data sent over a DHT. The request data may be received via the peer-to-peer device, and the message data sent over the DHT may be sent to a public channel with which the peer-to-peer device is in communication. The exemplary disclosed method may further include allowing only a sole user of the user device that is a mobile device, who is also the sole user of the peer-to-peer device, to modify the user data source that includes personal information of the sole user.

In at least some exemplary embodiments, the exemplary disclosed system may include a data access control module, comprising computer-executable code stored in non-volatile memory, a processor, a mobile device, and a first peer-to-peer device that stores a user data source. The data access control module, the processor, the mobile device, and the first peer-to-peer device may be configured to pair the mobile device with the first peer-to-peer device by using the mobile device to scan a barcode of the first peer-to-peer device, use the mobile device to send an activation command to the first peer-to-peer device, store an activation data of the first peer-to-peer device on a device ledger, use the mobile device to send a data command to the first peer-to-peer device, and use the first peer-to-peer device to send a portion of the user data source to a second peer-to-peer device based on the data command. Based on the activation data, the first peer-to-peer device may reject commands from all other devices other than the mobile device. Each of the first and second peer-to-peer devices may be Raspberry Pi devices. The data access control module, the processor, the mobile device, and the first peer-to-peer device may be configured to use the mobile device that is a smartphone to send a plurality of data commands to the first peer-to-peer device via an operation of a smartphone application.

In at least some exemplary embodiments, the exemplary disclosed system and method may be an automated system and method for controlling access to data. The exemplary system may include a plurality of nodes and connections for allowing communication between the nodes. An entity associated with a given node may control a single source of data associated with that given node, and may control access by third parties to the single source of data. The entity associated with the single source of data may allow, sell, revoke, or deny access to the single source of data. The exemplary disclosed system and method may be used in any suitable application for controlling access to data of a user such as an individual. For example, the exemplary system and method may be used in any suitable transfer or exchange of data between an individual (e.g., or organization) and another entity (e.g., a business or service provider) that takes place on a network or other system (e.g., the internet, a closed network, or any other suitable system).

Several advantages may be associated with the exemplary disclosed method and system. The exemplary method may provide tools to anonymize interaction in the cloud. The exemplary method may allow for a single source of truth for individual's information, under that individual's ownership and with the tools to share their information with others and to revoke this privilege, which may allow an individual to act as an enterprise of their information. Because substantially all data produced by the individual may be stored and managed from a single container, an individual may not be in a position to give away his or her information or fill in forms on platforms (e.g., but may instead provide such data using the exemplary system and method). For example, an individual may have greater control over his or her data security. The exemplary Lens described above extends the ability to control access to data and also manage an individual's time.

An illustrative representation of a computing device appropriate for use with embodiments of the system of the present disclosure is shown in FIG. 10. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration and many standardized communication links are well known to one skilled in the art, as explained in more detail and illustrated by FIG. 11, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 11, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 11, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

While multiple embodiments are disclosed, still other embodiments of the present disclosure will become apparent to those skilled in the art from this detailed description. There may be aspects of this disclosure that may be practiced without the implementation of some features as they are described. It should be understood that some details have not been described in detail in order to not unnecessarily obscure the focus of the disclosure. The disclosure is capable of myriad modifications in various obvious aspects, all without departing from the spirit and scope of the present disclosure. Accordingly, the drawings and descriptions are to be regarded as illustrative rather than restrictive in nature.

What is claimed is:

1. A data access control system, comprising:
a data access control module, comprising computer-executable code stored in non-volatile memory;
a processor;
a user device; and
a peer-to-peer device that stores a user data source;
wherein the data access control module, the processor, the user device, and the peer-to-peer device are configured to:
pair the user device with the peer-to-peer device;
use the user device to send an activation command to the peer-to-peer device;
store an activation data of the peer-to-peer device on a device ledger;
use the user device to send a data command to the peer-to-peer device; and
use the peer-to-peer device to send a portion of the user data source to a second device based on the data command;
wherein, based on the activation data, the peer-to-peer device rejects commands from all other devices other than the user device.

2. The data access control system of claim 1, wherein the peer-to-peer device has a storage medium storing information selected from the group consisting of a public key, a private key, a serial number, a one-time discovery code, and an activation code.

3. The data access control system of claim 1, wherein the activation data of the peer-to-peer device stored on the device ledger is a public key.

4. The data access control system of claim 3, wherein the public key verifies an identity of a user of the peer-to-peer device, which is the same identity and the same user as the user device.

5. The data access control system of claim 1, wherein the peer-to-peer device includes a barcode.

6. The data access control system of claim 5, wherein pairing the user device with the peer-to-peer device includes using the user device to scan the barcode that includes information selected from the group consisting of a serial number of the peer-to-peer device, a one-time discovery code, and the activation data that is a public key.

7. The data access control system of claim 1, wherein pairing the user device with the peer-to-peer device includes storing a key data on a local storage of the user device, the local storage being a non-network storage.

8. The data access control system of claim 1, wherein the user data source is a single source of truth of information of a sole user of the peer-to-peer device, who is also the sole user of the user device.

9. The data access control system of claim 8, wherein the sole user solely controls data of the user data source.

10. The data access control system of claim 8, wherein the data access control module, the processor, the user device, and the peer-to-peer device are configured to use the user device to send a revocation command to the peer-to-peer device to revoke access by the second device to the portion of the user data source.

11. A method, comprising:
providing a user device and a peer-to-peer device that stores a user data source;
pairing the user device with the peer-to-peer device;
using the user device to send an activation command to the peer-to-peer device;
storing an activation data of the peer-to-peer device on a device ledger;
receiving a request data from a second device via one of the user device and the peer-to-peer device, the request data including information requesting a portion of the user data source;
using the user device to send a data command to the peer-to-peer device; and
using the peer-to-peer device to send the portion of the user data source to the second device based on the data command;
wherein the user device is the sole device paired with the peer-to-peer device.

12. The method of claim 11, wherein the second device is selected from the group consisting of a second peer-to-peer device, a second user device, and a cloud-based service.

13. The method of claim 11, wherein the request data includes information requesting a subscription to the portion of the user data source.

14. The method of claim 13, further comprising using the user device to send a revocation command to the peer-to-peer device to revoke the subscription to the portion of the user data source.

15. The method of claim 11, wherein receiving the request data from the second device via one of the user device and the peer-to-peer device includes receiving a message data sent over a DHT.

16. The method of claim 15, wherein the request data is received via the peer-to-peer device, and the message data sent over the DHT is sent to a public channel with which the peer-to-peer device is in communication.

17. The method of claim 11, further comprising allowing only a sole user of the user device that is a mobile device, who is also the sole user of the peer-to-peer device, to modify the user data source that includes personal information of the sole user.

18. A data access control system, comprising:
a data access control module, comprising computer-executable code stored in non-volatile memory;
a processor;
a mobile device; and
a first peer-to-peer device that stores a user data source;
wherein the data access control module, the processor, the mobile device, and the first peer-to-peer device are configured to:
pair the mobile device with the first peer-to-peer device by using the mobile device to scan a barcode of the first peer-to-peer device;
use the mobile device to send an activation command to the first peer-to-peer device;
store an activation data of the first peer-to-peer device on a device ledger;
use the mobile device to send a data command to the first peer-to-peer device; and
use the first peer-to-peer device to send a portion of the user data source to a second peer-to-peer device based on the data command;
wherein, based on the activation data, the first peer-to-peer device rejects commands from all other devices other than the mobile device.

19. The data access control system of claim 18, wherein each of the first and second peer-to-peer devices are Raspberry Pi devices.

20. The data access control system of claim 18, wherein the data access control module, the processor, the mobile device, and the first peer-to-peer device are configured to use the mobile device that is a smartphone to send a plurality of data commands to the first peer-to-peer device via an operation of a smartphone application.
